(19) United States
(12) Patent Application Publication
(10) Pub. No.: US 2026/0161386 A1
(43) Pub. Date: Jun. 11, 2026

(54) METHOD FOR UPDATING AN AUTOMATIC DOOR SYSTEM AS WELL AS AUTOMATIC DOOR SYSTEM

(71) Applicant: Assa Abloy Entrance Systems AB, Landskrona (SE)

(72) Inventor: Marco HAURI, Galgenen (CH)

(21) Appl. No.: 18/707,693

(22) PCT Filed: Nov. 8, 2022
(86) PCT No.: PCT/EP2022/081147

§ 371 Date: May 6, 2024

(30) Foreign Application Priority Data
Nov. 9, 2021 (SE) 2130298-9

(51) Int. Cl. G06F 8/656; E05F 15/73

(52) U.S. Cl. CPC G06F 8/656; E05F 15/73; E05F 2015/767; E05Y 2900/132

(57) ABSTRACT

A method for updating an automatic door system (10) is provided, wherein the door system (10) comprises at least one door component (18), a door control unit (22), and a safety sensor (24) having a safety control unit (26). The method comprises the following steps:
the safety control unit (26) receives an update package including a firmware update for the door control unit (22) and/or for the drive unit (20),
the safety control unit (26) initiates an update process of the firmware of the door control unit (22) and/or the drive unit (20) from a deprecated firmware to the current firmware, and
the safety control unit (26) controls the update process and, if an abort condition is detected during the update process, the safety control unit (26) sets the door control unit (22) and/or the drive unit (20) back to the deprecated firmware.

Further, an automatic door system (10) is provided.

The invention concerns a method for updating an automatic door system as well as an automatic door system.

Automatic door systems, for example at buildings, are well known in the art. Today, automatic door systems often comprise a door control unit that drives the drive unit for actuating the actual door leaves. These door control units run a firmware which, just like any other piece of software, needs updates from time to time. Further, door systems are known that comprise a sensor including a camera, wherein the sensors have a control unit separate from the one of the door control unit.

To perform such a firmware update, it is necessary that a service technician trained to service the automatic door system is present at the specific automatic door system to supervise the update process and to verify that the door operates as it should be after the firmware has been updated.

Due to the special training needed by the service technician, firmware updates are expensive, time-consuming and—as the service technician has to drive to the automatic door system—have environmental costs.

It is therefore the object of the invention to provide a method for updating an automatic door system as well as an automatic door system that allows firmware updates to be performed more time efficient and environmentally friendly.

For this purpose, a method for updating an automatic door system is provided, wherein the door system comprises a door with at least one door component, in particular a movable door leaf, and at least one drive unit for actuating the at least one door component. The automatic door system further comprises a door control unit for controlling the drive unit, and a safety sensor having a safety control unit, wherein at least the door control unit and/or the drive unit is running with a deprecated firmware. The method comprises the following steps:
the safety control unit receives an update package including a firmware update to a current firmware at least for the door control unit and/or the drive unit,
the safety control unit initiates an update process of the firmware of the door control unit and/or the drive unit from the deprecated firmware to the current firmware, and
the safety control unit controls the update process of the firmware of the door control unit and, if an abort condition is detected during the update process, the safety control unit sets the door control unit and/or the drive unit back to the deprecated firmware.

It has been recognized by the inventors, that the safety control unit present in the safety sensor can be used to provide the necessary supervision of the update of the firmware of the door control unit and/or of the drive unit, as it is a control unit independent of the door control unit and the drive unit. Thus, enabling the safety sensor to perform the necessary supervision, it is not necessary for the service technician to drive to the automatic door system in person or to supervise the update process at all. Thus, update processes can be performed easier and environmentally friendly.

A firmware update may be understood as to include the entire code of the current firmware, a patch to replace only parts of the code of the firmware and/or an installer to execute the change of code and/or data.

In an embodiment, the update package includes a firmware update for the safety control unit, wherein the safety control unit performs an update process of its firmware, in particular before initiating the update process of the firmware of the door control unit. This way, also the firmware of the safety control unit may be updated.

For example, if an abort condition is detected during the update process of the firmware of the safety control unit, the safety control unit is set back to the deprecated firmware.

It is conceivable that the update process of the firmware of the door control unit is initiated at a later point in time after the update process of the firmware of the safety control unit has been completed. Thus, the duration at which the door is inoperative at a time is reduced.

In an aspect, the update process of the firmware of the door control unit and/or of the safety control unit includes a reboot of the door control unit or the safety control unit, respectively, and/or a verification of the correct operation of the door so that critical tasks are performed during the supervised update process and it is ensured that the door is fully operational.

To ensure the safety even in unforeseen situations, if the update process of the firmware of the safety control unit leaves the safety control unit longer than a predetermined duration or permanently inoperative, the door control unit may switch to a safe operating mode and/or if the update process of the firmware of the door control unit leaves the door control unit longer than a predetermined duration or permanently inoperative, the drive unit switches to a safe operating mode.

For example, in the safe operating mode the door is always open.

In order to mitigate problems before the update has been started, prior to initiating any update process, the safety control unit may verify the received update package with respect to its authenticity, completeness, integrity and/or correctness, in particular cryptographically.

In an aspect, the safety control unit determines a suitable point in time for initiating the update process of the firmware of the door control unit, of the drive unit and/or of the safety control unit; and/or a suitable point in time for rebooting the door control unit, the drive unit and/or the safety control unit. Thus, the update process is initiated automatically.

An abort condition may be a software error during the update process, any condition that casts doubt on the correct operation of the door system and/or any condition that does not allow for the door system to be inoperative for the time necessary to complete the update process, in particular a failed verification of the update package, an indication that the time necessary to complete the update process is shorter than the time the door is not being used, a failed verification of the correct operation of the door and/or the absence of a supervisor. This way, possible impairments of the operation of the door are detected early.

In another embodiment, the safety sensor comprises a camera, wherein the field of view of the camera includes the door component, the track of the door and/or a safety zone in front of the door component, wherein the camera captures at least one recording of the field of view, the safety control unit evaluates the captured recording and sends instructions to the door control unit to operate the door based on the captured recording, improving the safety of the door system.

In order to improve the safety also during an update process, the safety control unit may detect an abort condition based on the recording captured by the camera.

Abort conditions of the second, third or fourth category of abort conditions may be detected using the camera.

Further, abort condition of all categories may be determined by the safety control unit, in particular by receiving update errors or by interpreting sensor readings.

For a more precise evaluation, the safety sensor and/or the safety control unit may determine the suitable point in time for initiating the update process of the firmware of the door control unit, of the drive unit and/or of the safety control unit and/or a suitable point in time for rebooting the door control unit, the drive unit and/or the safety control unit based on the recording captured by the camera and/or the past usage of the door, in particular the following steps are performed for the determination of a suitable point in time:
the safety sensor and/or the safety control unit estimates based on the recording the length of time that the door will not be used,
the safety sensor and/or the safety control unit determines whether the length of time exceeds the time necessary to complete the update process and/or a reboot of the firmware of the door control unit, of the drive unit and/or of the safety control unit, and
if so, the safety sensor initiates the update process and/or the reboot of the firmware of the door control unit, of the drive unit or of the safety control unit, respectively.

The time necessary to complete the update process may be included as information in the update package and/or determined by the safety control unit based on the firmware update.

Further, during presence of an abort condition, update processes are preferably not initiated.

For a more precise determination of a suitable point in time, the mode of operation of the door, the past usage of the door and/or the history of the modes of operation used may be taken into account for the determination of a suitable point in time.

In an aspect, during the update process of the door control unit, the safety sensor and/or the safety control unit continues to estimate the length of time that the door will not be used based on at least one further recording captured, and if the length of time decreases below the time remaining to complete the update process of the door control unit, an abort condition is detected. This way, unforeseen behavior of persons can be taken into account.

In an embodiment, the verification of the correct operation of the door is performed by the safety sensor based on the recording captured by the camera, in particular the following steps are performed for the verification of the correct operation of the door:
the safety control unit instructs the door control unit to operate the door component to perform a specific test movement,
the camera captures a recording,
the safety control unit recognizes the actual movement of the door component in the recording and evaluates whether the actual movement corresponds to the test movement, and
if the actual movement corresponds to the test movement, the verification is successful and, if the actual movement does not correspond to the test movement, in particular whether the actual movement is within a safe operation space, the verification is not successful constituting an abort condition.

By using an automated verification, even the verification can be performed without the need for a trained service technician.

After having received the instructions, the door control unit may attempt to operate the door component according to the instructions, wherein the camera captures a recording of the attempt.

The safe operation space of the door may be part of the update package and/or may comprise target values and/or target ranges for parameters characterizing the correct and safe operation of the door. Example for values and ranges defining the safe operation space are the maximum allowed temperature of the actuator, a range of a trajectory of the door component (e.g. a range of the allowed distance between the door leaf and the ground), firmware version, compatibility with subsystems, door system configuration compatibility or the like.

In order to provide a full verification of the correct operation of the door system, the following further steps may be performed:
the safety control unit receives and/or determines an actual measurement value from a sensor of the door system and/or from the drive unit,
the safety control unit evaluates whether or not the actual measurement value corresponds to a target value or is within a target range defined by a safe operation space, and
if the actual measurement value corresponds to the target value or is within the target range, the verification in this regard is successful.

To improve the safety during an update process even further, the safety control unit may recognize the presence of a supervisor at the door based on an input by the supervisor at a user terminal, wherein the absence of a supervisor constitutes an abort condition, and/or wherein the safety control unit may recognize a person approaching the door based on the further recording captured, wherein a person approaching the door constitutes an abort condition.

The input of the supervisor may be an authentication of himself at a terminal of the automatic door system or at a user interface of the mobile device connected to the door system. Information about this authentication is then transmitted to the safety control unit which in turn determines that a supervisor is present.

The supervisor is not regarded as a “person approaching the door” in this case.

The supervisor may be an untrained person (with respect to the door system), for example a janitor or a superintendent of the building the door system is installed in.

The safety control unit may instruct the supervisor to perform certain tasks before an update may take place, like putting up warning signs or locking the door. The supervisor may be instructed to perform the task by means of the display terminal of the automatic door system or an interface of the mobile device, respectively. The safety control unit may, using the recordings of the camera and/or a sensor reading, e.g. a sensor of a locking mechanism of the door system, determine whether the supervisor has carried out his task correctly, wherein no execution or an incorrect execution of the task constitutes an abort condition.

For precise and efficient evaluations, the safety control unit and/or the safety sensor may comprise an adaptive deterministic algorithm, a machine learning algorithm, a support vector machine and/or a trained artificial neural network, configured and/or trained to recognize an abort condition, a hazard, a person, a supervisor and/or the actual movement of the door component in the captured recording, and/or configured and/or trained to estimate the length of time that the door will not be used based on the captured recording.

In an embodiment, the safety control unit receives the update package via a wireless or wired connection, in particular from a remote sever or from a mobile device in the vicinity of the door system, so that the update packages are distributed easily.

For example, the mobile device is only temporarily connected to the safety control unit.

In an aspect, the initiation of an update process, the occurrence of an abort condition and/or a successful verification step is recorded in a log, in particular wherein the log is transmitted to a remote server or a mobile device. Using the log, the verification may be resumed and in case that the log is transmitted back, bug fixing for coming versions of the firmware is simplified.

In an embodiment, the safety control unit, the door control unit and/or the drive unit comprises a memory storing the deprecated firmware and the current firmware simultaneously, in particular both in a fully operational fashion, wherein the safety control unit, the door control unit and/or the drive unit is set back, if necessary, to the deprecated firmware by rebooting the respective unit in the deprecated firmware. By having two fully operational firmware versions installed at the respective unit, a switch between the firmware version can be performed by a simple reboot, drastically reducing the time that the respective unit is inoperative.

In an aspect, the update package includes a firmware update for a subsystem of the automatic door system, in particular for an operation terminal, a display terminal, a locking mechanism and/or an escape route terminal of the door system, wherein the safety control unit initiates an update process of the firmware of the subsystem from the deprecated firmware to the current firmware, the safety control unit controls the update process of the firmware of the subsystem, and if an abort condition is detected during the update process, the safety control unit sets the subsystem back to the deprecated firmware. This way, all subsystems of the door system may be updated without the need for a service technician.

The features and advantages discussed with respect to the update of the door control unit and/or drive unit also apply to the update of the subsystem and vice versa.

For above mentioned purpose, an automatic door system is provided comprising at least one door component, in particular a movable door leaf, at least one drive unit for actuating the at least door component, a door control unit for controlling the drive unit, and a safety sensor having a safety control unit, wherein the door system is configured to carry out the method as described above, in particular wherein the safety sensor comprises a camera.

The features and advantages mentioned with respect to the method also apply to the automatic door system and vice versa.

Further features and advantages will be apparent from the following description as well as the accompanying drawings, to which reference is made. In the drawings:

FIG. 1: shows schematically an automatic door system according to the invention,

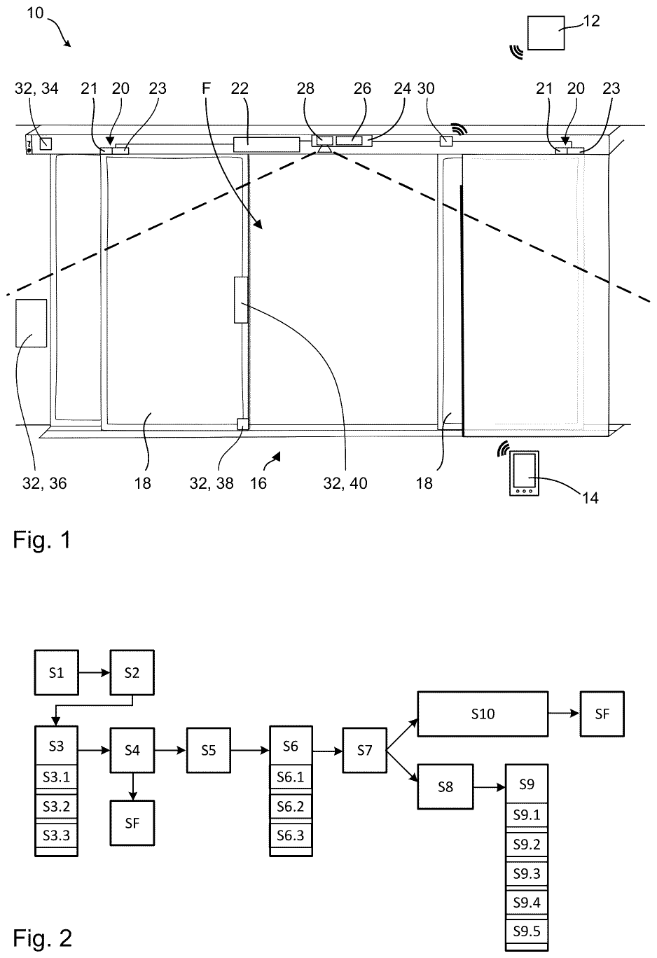

FIG. 2: shows a flowchart of a method according to a first embodiment of the invention, and

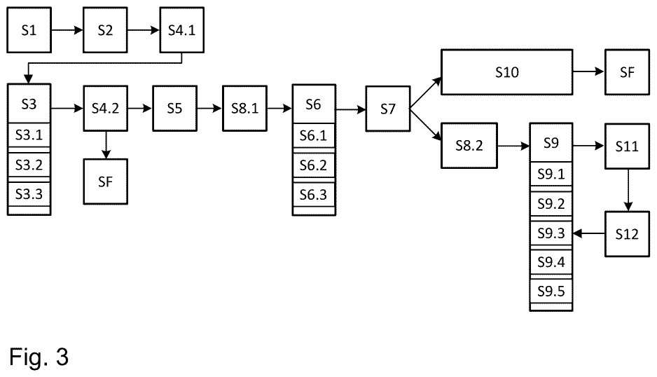

FIG. 3: shows a flowchart of a method according to a second embodiment of the invention.

FIG. 1 shows schematically an automatic door system 10 according to the invention, a remote server 12 and a mobile device 14.

The automatic door system 10 has a door 16 with at least one door component 18, a drive unit 20, a door control unit 22 and a safety sensor 24.

In the shown embodiment, the door 16 is a sliding door with two door components 18 being movable door leaves. Thus, also two drive units 20 are provided.

The door 16 may as well be a swing door, a revolving door, a folding door or the like. The method of operation remains the same.

The automatic door system 10 may further comprise subsystems 32, like an operation terminal 34, a display terminal 36, a locking mechanism 38 for locking the door 16 and/or an escape route terminal 40.

The safety sensor 24 and the drive unit 20 are connected to the door control unit 22, wherein the door control unit 22 is configured to control the drive unit 20.

Each of the drive units 20 comprise an actuator 21, like an electric motor, and power electronics 23 for the actuator 21. The power electronics also run a firmware.

Each of the drive units 20 is associated with one of the door components 18 and is designed to move the respective door component 18 along a track. The door components 18 may be moved individually from one another.

In particular, the door components 18 are movable such that between them a passage can be opened, wherein the width of the passage is adjustable by the door control unit 22.

The door control unit 22 is, for example, an embedded system running a firmware.

The safety sensor 24 comprises a safety control unit 26 and a camera 28.

The camera 28 is located above the door 16 and monitors the track of the door 16, i.e. the movement path of the door components.

The camera 28 may be a single camera, a stereo camera, a time-of-flight 3D camera, an event camera or a plurality of cameras.

The field of view F of the camera 28 includes the track of the door 16, in particular the track of the door leaves, and a safety zone in front of the door leaves. The safety zone may extend at least 20 cm in front of the door leaves.

The field of view F of the camera 28 may cover an area of up to 5 m, preferably up to 7 m, more preferably still up to 10 m in front of the door 16, measured on the ground.

The safety sensor 24 is an integral part of the safety functionality of the door system 10. Mainly, the camera 28 monitors the track of the door 16, i.e. the movement path of the door leaves, and forwards the recording to the safety control unit 26. The safety control unit 26 instructs the door control unit 22 to ensure that the door 16 is operated safely. In particular, to ensure that persons, for example vulnerable persons such as children or elderly people, present in the track of the door 16 are not touched or even harmed by a movement of the door component 18.

Further, the safety sensor 24 is configured to detect persons wishing to pass the door 16.

The camera 28 captures at least one recording, for example a single picture, a series of pictures and or a video, of the field of view F and transmits the recording to the safety control unit 26.

The safety control unit 26 evaluates the captured recording and, based on the recording, sends instructions to the door control unit 22 to operate the door 16 accordingly.

For example, safety control unit 26 determines whether or not persons are present in the field of view F of the camera, i.e. the recording, and whether or not a person desires to pass the door 16. If so, the safety control unit 26 instructs the door control unit 22 to open the door 16.

Then the door control unit 22 instructs the drive units 20 to create the desired motion of the respective door component 18 to open the door.

To this end, the safety control unit 26 may comprise an adaptive deterministic algorithm, a machine learning algorithm, a support vector machine and/or a trained artificial neural network, configured and/or trained to recognize persons in the recording that desire to pass the door 16.

The safety control unit 26 may also be an embedded system running a firmware.

It is to be noted that the safety control unit 26 and door control unit 22 are separate control units with different purposes and running different firmware.

In particular, the safety control unit 26 and the door control unit 22 operate in a way such that one may be operative while the other reboots or is inoperative while updating itself. However, the automatic door system 10 has only the full range of functions if both the safety control unit 26 and the door control unit 22 are operative and are working together.

The safety control unit 26 and/or the door control unit 22 is connected to the remote server 12 and/or to the mobile device 14.

For example, the automatic door system 10 comprises a connectivity module 30, like a wireless communication module or an Ethernet module, wherein the connectivity module 30 is connected of the safety control unit 26 and/or the door control unit 22.

The connection between the connectivity module 30, the safety control unit 26 and/or the door control unit 22 may be realized by a bus of the automatic door system 10. Further, the drive units 20 and/or sensors may be connected to the bus.

The connectivity module 30 may be part of the safety sensor 24, the safety control unit 26 and/or the door control unit 22.

It is also conceivable that the safety control unit 26 is part of the door control unit 22.

The remote server 12 is, for example, a server connected to the internet located at a remote location from the automatic door system 10.

It is also conceivable, that the remote server 12 is located on the same premise as the automatic door system 10.

The connection of the safety control unit 26 and/or the door control unit 22 to the remote server 12 may be a wired connection or a wireless connection in the sense that the safety control unit 26 has established a wireless connection to a gateway in the vicinity of the automatic door system 10, which is in turn connected, for example via the Internet, to the remote server 12.

On the remote server 12, update packages including a firmware update for the safety control unit 26 and or the door control unit 22 are stored.

The update packages include, for example, as a firmware update the entire code of the current version of the firmware to replace the entire code of the firmware on the respective control unit 22, 26. It is also possible, that the firmware update includes only parts of the code of the firmware so that only parts of the code of the firmware are updated. Further, the firmware update may include an installer to execute the change of code.

Further, the firmware update may include information on a safe operation space of the door 16. The safe operation space comprises target values and/or target ranges for parameters characterizing the correct and safe operation of the door.

Example for values and ranges defining the safe operation space are the maximum allowed temperature of the actuator 21, a range of a trajectory of the door component 18, e.g. a range of the allowed distance between the door leaf and the ground, the firmware version, the compatibility with subsystems 32 (e.g. operation terminal 34, display terminal 36, locking mechanism 38 and/or escape route terminal 40), door system configuration compatibility or the like.

The mobile device 14 may be a laptop, a tablet, a smart phone or any other smart device. The mobile device 14 may belong to a service technician, a janitor, a superintendent of the building the door system 10 is installed in or any other person authorized to initiate a firmware update of the door system 10.

The mobile device 14 is brought into the vicinity of the automatic door system 10 and is connected to the safety control unit 26 either that wirelessly, for example using Wi-Fi, Bluetooth or the like, or via a cable.

Just like the remote server 12 the mobile device 14 has firmware updates stored within. As the mobile device 14 will be carried away from the owner afterwards, the mobile device 14 is connected to the safety control unit 26 only temporarily.

The firmware of the safety control unit 26, the firmware of the door control unit 22 as well as the firmware of the drive unit 20, i.e. the firmware of the power electronics 23, may become deprecated as newer versions of the firmware become available. Thus, firmware updates become necessary.

To update the firmware of the door control unit 22, the drive unit 20 and of the safety control unit 26 to the current firmware, the method according to the invention as illustrated in FIG. 2 is performed. FIG. 2 shows a flowchart of a first embodiment of the method according to the invention.

For simplicity, the firmware update of one or both of the drive units 20 is not explained in detail in the following. A firmware update of the drive unit 20 may be carried out in the same way as a firmware update of the door control unit 22 as both units are essential for the safe operation of the door system 10.

For example, using the following exemplary method, instead of the firmware of the door control unit 22, the firmware of the drive unit 20 may be updated, i.e. each step of the following exemplary method applied to the door control unit 22 is then applied to the drive unit 20 instead.

Alternatively, the firmware of the door control unit 22 and of the drive unit 20 may be updated simultaneously, i.e. each step of the following exemplary method applied to the door control unit 22 is also being applied to the drive unit 20

In a first step S1, the safety control unit 26 receives at least one update package including a firmware update from the remote server 12 or from a connected mobile device 14. The transmission of the update package may be initiated by the safety control unit 26, the remote server 12 or the mobile device 14.

The update package comprises in this example a firmware update for the safety control unit 26 as well as a firmware update for the door control unit 22.

In a second step S2, the safety control unit verifies the received update packages with respect to the authenticity, the completeness, the integrity and/or correctness. This step may also be carried out by the door control unit 22.

This verification may be done cryptographically, for example using hashes and/or digital signatures, as known in the art.

If the verification has been successful, the safety control unit 26 initiates the update process. The initiation may be recoded in a log by the safety control unit 26.

In the explained example, the update process of the safety control unit 26 itself is performed first before the update process of the door control unit 22.

It is also conceivable, that the update process of the door control unit 22 is performed first or that only one of the update processes is performed at all, if the update package includes only a firmware update for one of the two control units 22, 26.

In the next step S3, the safety control unit 26 begins to wait for a suitable point in time at which the update process may be performed without compromising the safety of the door system 10. This step may also be carried out by the door control unit 22.

To this end, the safety control unit 26 (or the door control unit 22) determines the suitable point in time for initiating the actual update process of its firmware from the deprecated firmware to the current firmware.

To this end, the safety control unit 26 evaluates the recordings captured by the camera 28 to determine whether or not enough time until the next usage of the door 16 will be available for the update.

In addition or in the alternative, the safety control unit 26 may evaluate the current mode of operation of the door 16. For example, whether the door 16 is in a state or mode where the safety control unit 26 is not in use, e.g. if the door 16 is locked. In such a mode of operation an update is possible without risks.

Further, for the determination of the suitable point in time, the safety control unit 26 may take into consideration past usages of the door 16, for example usage patterns such that the door 16 is rarely used during night time, or a history of the modes of operation, for example that the door is locked every day from 2 a.m. to 5 a. m. In such intervals, an update may perform easier so that the suitable point in time should be placed in such an interval so that the update is scheduled at such a time.

To this end, the door usage and the changes of modes of operation are logged by the safety sensor 24 and/or the door control unit 22 creating information about past usage of the door 16 and/or a history of modes of operation.

For example, the safety sensor 24 evaluates the recordings of the camera 28 with respect to any persons in the field of view that might want to pass the door. This condition is broader than the condition to send instructions to the door control unit 22 to open the door 16 as even persons for the away than person waiting to pass the door immediately are taken into consideration. The safety control unit 26 then determines the length of time that the door 16 will not be used, e.g. the length of time that that persons, if acting normally, would not come into the vicinity of the door component 18 or the time the door 16 will stay open, even if the track of the door is clear and the door 16 could be safely closed (step S3.1).

Before, simultaneously or afterwards, the safety control unit 26 determines the time necessary to complete the update process of the firmware of itself. This may be done by evaluating the update package. The time necessary to complete the update process may be included as additional information apart from the code of the firmware and/or an installer in the update package (step 3.2).

The safety control unit 26 then compares the estimated length of time that the door 16 will not be used with the time necessary to complete the update process and if the time necessary to complete the update process is smaller, the safety control unit 26 determines that the current point in time is suitable to initiate the update process of itself (step S3.3).

Then, in step S4 and if no abort condition is present, as will be explained later, the safety control unit 26 initiates the update process of itself. The initiation may be recoded in a log by the safety control unit 26.

The update process of the firmware of the safety control unit 26 includes writing the current firmware contained in the update packages in the memory, in particular a flash-memory, of the safety control unit 26 and rebooting the safety control unit 26. During this update process, at least until the reboot is completed, the safety control unit 26 is inoperative. Usually the update process takes about 20 to 30 seconds. If the safety control unit 26 is inoperative an unusually long time, e.g. a longer than a duration predefined in the update package or elsewhere, an abort condition is detected and the door control unit 22 and/or the drive unit 20 switch to a safe operating mode.

During the update process of the safety control unit 26, the door control unit 22 or a supervising module of the safety control unit 26 monitor the update process with respect to the occurrence of abort conditions.

An abort condition may be a software error during the update process, for example of the safety control unit 26 has crashed during the update process, any condition that casts doubt on the correct operation of the door system 10, or if the time available for the update runs out.

If abort condition is detected, the update process of the firmware of the safety control unit 26 is aborted, in this embodiment meaning that the deprecated firmware is reinstalled setting the safety control unit 26 back to the latest version of the firmware that had worked properly.

Further, the abort condition is recorded in a log. The log may be transmitted to the remote server 12 and/or the mobile device 14.

The abort conditions may have different categories. The first category relates to the question whether or not the current firmware is in itself running correctly. Abort conditions of the second category relate to checks whether the current firmware is running correctly during operation of the door. Abort conditions of the third category relate to checks whether conditions defined in norms or the like are observed when the current firmware is used. And the fourth category of abort conditions of the second category relate to checks whether the current firmware leads to an improvement in the door functionality compared to the functionality of the deprecated firmware.

For example, abort conditions relating to the safe operating space are of the third category.

Further, abort condition of the second, third and fourth category may be determined by the safety control unit 26 using the recording of the camera 28.

During the time of the update process of the firmware of the safety control unit 26 that the safety control unit 26 is inoperative, the door control unit 22 may switch to a safe operating mode, in particular if a given time limit for the update process is exceeded. A safe operating mode may be realized by operating the drive unit 20 open the door 16 fully, in particular with a very slow speed of the door component 18. The door 16 is then kept open until the door control unit 22 leaves the safe operating mode or the door 16 is in a locked state and will not change its state until the safety control unit 26 is operational again.

Further, if the update process of the firmware of the safety control unit fails to the extent that leaves the safety control unit 26 permanently inoperative, the door control unit 22 and/or the drive unit 20 also switches to the safe operation mode. Once the reboot of the safety control unit 26 has been completed, the update process of the firmware of the safety control unit 26 is also complete (Step S5). Thus, the update process of the door control unit 22 may be initiated.

Once the reboot of the safety control unit 26 has been completed, the update process of the firmware of the safety control unit 26 is also complete. Thus, the update process of the door control unit 22 may be initiated.

The update process of the firmware of the door control unit 22 is controlled fully by the safety control unit 26, in particular with regards to the time at which the update process of the firmware of the door control unit 22 is initiated.

The update process of the door control unit 22 does not have to be initiated right after the completion of the update process of the firmware of the safety control unit 26 but the firmware update of the door control unit 22 may be performed at a later point in time.

In step S6, the safety control unit 26 determines a suitable point in time for initiating the update process of the door control unit 22. This step may also be carried out by the door control unit 22.

The determination of a suitable point in time for the update process of the firmware of the door control unit 22 is very similar to the one explained in step S3 for the determination of the suitable point in time for the update process of the firmware of the safety control unit 26.

As explained above, the safety control unit 26 estimates based on the recordings of the camera 28 the length of time that the door 16 will not be used (step S 6.1), determines (steps S6.2, S6.3) whether or not this time exceeds the time necessary to complete the update process of the door control unit 22 (which may also be given as information in the update package and/or is determined by the safety control unit 26). If enough time is available, the safety sensor 24 and/or the safety control unit 26 determines that it is a suitable point in time for initiating the update process of the firmware of the door control unit 22.

Further, it may be necessary by laws or regulations, that a supervisor must be present at the door 16 to prevent persons to come close to the door. The supervisor does not need to be a trained service technician of the door system 10, but may be an untrained person with respect to the door system 10, for example a janitor or a superintendent of the building the door system 10 is installed in.

If the presence of such a supervisor is necessary, the safety control unit 26 determines whether or not a supervisor is present in the vicinity of the door 16 (step S7).

For example, the supervisor has to authenticate himself at one of the terminals 34, 36 of the automatic door system 10 or at a user interface of the mobile device 14 connected to the door system 10. Information about this authentication is then transmitted to the safety control unit 26 which in turn determines that a supervisor is present.

It may be necessary that the supervisor has to perform certain tasks before an update may take place, like putting up warning signs or locking the door 16. The supervisor may be instructed to perform a task using the display terminal or any other interface of the automatic door system 10 or of the mobile device 14, respectively.

Using the recordings of the camera 28 and/or a sensor reading, e.g. a sensor of a locking mechanism of the door system 10, the safety control unit 26 is able to determine whether the supervisor has carried out his task correctly.

If the point in time is suitable, the supervisor is present in the vicinity of the door 16 and, optionally, has carried out the task correctly, the safety control unit 26 may initiate the update process of the firmware of the door control unit 22 (step S8).

The update process of the firmware of the door control unit 22 is very similar to the update process of the firmware of the safety control unit 26. In particular, it includes times in which the door control unit 22 is inoperative, in particular due to a reboot of the door control unit 22.

Further, the update process of the firmware of the door control unit 22 may include also the verification of the correct operation of the door 16 after the actual firmware has been updated and/or a reboot has been performed.

The verification of the correct operation of the door 16 may be performed by the safety control unit 26 (step S9).

A correct operation may be assumed if the door behavior is within the limits defined by the safe operation space.

The verification by the safety control unit 26 may be based on recordings received from the camera 28.

For example, the verification of the correct operation of the door may include that the safety control unit 26 instructs the door control unit 22 to operate the door 16 in a certain way, i.e. so that the door component 18 performs a specific movement, called test movement in the following (S9.1).

The test movement may be defined in the update package, for example as part of the safe operation space.

The door control unit 22 may then attempt to operate the door 16, in particular the door component 18 according to the instructions, using the drive unit 20 (step S9.2).

Thus, the door control unit 22 drives the drive unit 20 so that, under correct operation, the door component 18 will perform the test movement instructed by the safety control unit 26.

In the meantime, the camera 28 captures a recording or continues to capture a recording at least during the time the door control unit 22 attempts to operate the door 16 according to the instructions of the safety control unit 26 (step S9.3)

The recordings are transmitted to the safety control unit 26 and in step S 9.4 the recordings are evaluated by the safety control unit 26. To this end, the safety control unit 26 recognizes the actual movement of the door components 18 of the door 16 in response to the instruction given to the door control unit 22 and evaluate whether the actual movement derived from the recordings correspond to the test movement (step S9.5)

If the actual movement corresponds to the test movement, the verification in this regard is successful

In addition or in the alternative, during the attempt to operate the door 16 (step 9.3), the safety control unit 26 may receive actual measurement values from sensors and/or the drive unit 20, for example the actual temperature of the actuator 21, the actual output current of the power electronics 23, the actual time needed to open the door 16 or the like.

Simultaneously, before or after steps 9.3, 9.4 and 9.5, the safety control unit 26 compares the actual measurement value to a corresponding target value or a corresponding target range.

The target values and/or the target range may be supplied to the safety control unit 26 as part of the update package, for example as part of the safe operation space.

If the actual measurement values correspond to the corresponding target values or are within the corresponding target range, the verification in this regard is successful.

If the verification in all regards has been successful, the update process of the firmware of the door control unit 22 is complete and the door control unit 22 runs with the current firmware.

If the actual movement does not correspond to the test movement or any of the measurement values does not match the corresponding target values or range, the verification is not successful constituting an abort condition.

In this case, the safety control unit 26 sets the door control unit 22 back to the deprecated firmware, i.e. the firmware used before the firmware update.

The results of each aspect of the verification, regardless whether the verification has been positive or negative, is recorded in the log by the safety control unit 26. The log may be transmitted to the remote server 12 and/or the mobile device 14 for analysis.

During the whole update process of the firmware of the door control unit 22, the safety control unit 26 monitors the process for the occurrence of an abort condition (step S10).

The abort condition may be of the same type as explained with respect to the firmware update of the safety control unit 26. Abort conditions may be detected based on the recordings captured by the camera 28 during the update process.

For example, the safety sensor 24, in particular the safety control unit 26 and the camera 28 continue to estimate the length of time that the door will not be used based on at least one further recording, in particular a continuous recording during the update process.

If the length of time that the door 16 will not be used decreases during the update process below the time remaining to complete the update process of the door control unit 22, an abort condition is detected. The time remaining to complete the update process may be determined by the safety control unit 26.

Further, if a supervisor is mandatory for the update process to be performed, the safety control unit 26 determines based on further recordings captured, whether or not a supervisor is still present in the vicinity of the door 16.

The absence of a supervisor or a detected inattention of the supervisor to his duty of preventing persons to past the door, constitutes an abort condition leading to the abort of the update process.

Further, the safety control unit 26 recognizes whether or not a person approaches the door based on the further recordings captured, wherein the presence of a person approaching the door also constitutes an abort condition. Of course, in this case, only persons not being the supervisor are taken into account.

If the time that the door 16 will not be used is smaller than the remaining time of the update, this constitutes an abort condition. In this case, it is not allowed that the door 16 is inoperative for the time necessary to complete the update process.

If the safety control unit 26 comprises an adaptive deterministic algorithm, a machine learning algorithm, a support vector machine and/or a trained artificial neural network, it may be configured or trained to recognize the above abort conditions, in particular a hazard, a person, the supervisor and/or the actual movement of the door component 18 in the captured recording.

The adaptive deterministic algorithm, the machine learning algorithm the support vector machine, and/or the trained artificial neural network may be configured and/or trained to estimate the length of time that the door 16 will not be used based on the captured recordings of the camera 28.

If the verification in step S9 has been successful without the occurrence of abort condition, the automatic door system 10 has been successfully updated to the current firmware.

This process has been performed without the need of a trained service technician. Thus, it is not necessary for a service technician to drive to the automatic door system 10, reducing environmental impact and saving time.

Supervision may, if necessary, be performed by an untrained person with respect to the automatic door system 10.

Thus, updating an automatic door system 10 can be carried out in a much easier and more cost-efficient way.

It is possible, that the update package only includes an update for the firmware of the safety control unit 26 or the firmware of the door control unit 22. In these cases, steps S6 to as 10 or steps S3 to S5, respectively, are omitted.

The firmware of one or more of the subsystems 32 of the door system 10, i.e. the operation terminal 34, the display terminal 36, the locking mechanism 38 and/or the escape route terminal 40 may be updated by the safety control unit 26 in the same manner as an update of the door control unit 22.

In this case, the update package may include a firmware update for the respective subsystem 32.

In a second embodiment, the time that the unit receiving the update is inoperative may be reduced by having the current firmware and the deprecated firmware in the memory of the respective device in an executable state. This way, only a reboot is necessary to change from the deprecated firmware to the current firmware and vice versa.

The method of the second embodiment corresponds to the one of the first embodiment so that only the differences are discussed in the following. A flow-chart of the second embodiment is shown in FIG. 3.

The drive unit 20, the door control unit 22, the safety control unit 26 and/or any other unit that may receive updates of their firmware may have a memory that is designed to accommodate two versions of the firmware in a fully operative way, i.e. a bootable fashion. In particular, the memory is chosen large enough and/or the memory is designed as a dual-banked flash memory.

In this second embodiment, the update process as explained above (Steps S4; S8 in the first embodiment), namely writing the current firmware contained in the update packages in the flash-memory of the respective unit 20, 22, 26 and rebooting the respective unit 20, 24, 26 is split into two substeps.

The first substep S4.1 or S8.1 includes writing the current firmware contained in the update packages in the flash-memory or the second bank of the dual-banked flash memory without altering and/or interfering with the firmware that is currently running.

Thus, during the first substep S4.1 or S 8.1, the respective unit 20, 22, 26 remains operative so that the first substep S4.1 or S8.1 does not need to be performed at a suitable point in time during which no usage of the door 16 is expected.

For example, substep S4.1 is carried out after the verification of the package (Step S2) but before the determination of the suitable point in time (Step S3).

Likewise, the substep S8.1 may be carried out after the update of the safety control unit 26 has been completed (Step S5) and before the determination of the suitable point in time for the update of the door control unit 22 (Step S6). In fact, substep S8.1 may also be carried out at an earlier point in time, for example before, simultaneously to or directly after substep S4.1.

Any software error during these substeps S4.1 and S8.1 also lead to an abort condition.

Once the current firmware has been written into the memory of the respective unit 20, 22, 26, the change from the deprecated firmware to the current firmware is performed by a reboot, i.e. indicating in the bootloader that the current firmware shall be booted and initiating a reboot.

This reboot is the second substep S4.2 or S8.2 and the respective unit 20, 22, 26 is inoperative during the reboot. The substeps S4.2 and S8.2 are performed at the time of steps S4 and S8 of the first embodiment, respectively.

However, compared to the first embodiment, the time that the respective unit 20, 22, 26 is inoperative is drastically reduced as no data has to be copied and is stored persistently. A reboot process may take as little as 0.1 to 5 seconds. This has an impact on the determination of the suitable point in time (Steps S3, S6).

Thus, in the second embodiment, in steps S3 and S6 a suitable point in time for rebooting the respective unit 20, 22, 26 is determined. As the time necessary for rebooting is rather short, a suitable point in time can be found much more easily.

Further, in this second embodiment there is no need to remove the deprecated firmware from the memory of the respective unit 20, 22, 26. Thus, the respective unit 20, 22, 26 may be set back very easily by performing another reboot, this time into the deprecated firmware. This allows to switch back and forth between the deprecated firmware and the current firmware within second.

In the second embodiment, the verification of the correct operation at the door 16 (step S9) may be performed in a stepwise fashion.

During the verification, multiple tests are being performed. If during the verification the safety control unit 26 determines that the door 16 is suddenly to be used again, i.e. that the length of time that the door 16 will not be used is smaller than the time necessary to perform the remaining verification, an abort condition is detected.

Thus, the safety control unit 26 initiates a reboot of the respective unit 20, 22, 26 into the deprecated firmware. At the same time, the results of the verification so far, e.g. test results and/or information about successfully performed test, can be stored in the memory (Step S11).

The next time a suitable point in time is recognized by the safety control unit 26, the respective unit 20, 22, 26 is rebooted once again into the current firmware and the verification can resume where it had been interrupted based on the stored results of the verification (Step S12).

These steps may be repeated until the entire verification procedure has been carried out successfully. Thus, the duration of the time in which the door is inoperative can be reduced further.

1. Method for updating an automatic door system (10), wherein the door system (10) comprises a door (16) with at least one door component (18), in particular a movable door leaf and at least one drive unit (20) for actuating the at least one door component (18), a door control unit (22) for controlling the drive unit (20), and a safety sensor (24) having a safety control unit (26), wherein at least the door control unit (22) and/or the drive unit (20) is running with a deprecated firmware, wherein the method comprises the following steps:
the safety control unit (26) receives an update package including a firmware update to a current firmware at least for the door control unit (22) and/or the drive unit (20),
the safety control unit (26) initiates an update process of the firmware of the door control unit (22) and/or of the drive unit (20) from the deprecated firmware to the current firmware, and
the safety control unit (26) controls the update process of the firmware of the door control unit (22) and/or of the drive unit (20) and, if an abort condition is detected during the update process, the safety control unit (26) sets the door control unit (22) and/or of the drive unit (20) back to the deprecated firmware.

2. Method according to claim 1, characterized in that the update package includes a firmware update for the safety control unit (26), wherein the safety control unit (26) performs an update process of its firmware, in particular before initiating the update process of the firmware of the door control unit (22).

3. Method according to claim 1, characterized in that the update process of the firmware of the door control unit (22) and/or of the safety control unit (26) includes a reboot of the door control unit (22) or the safety control unit (26), respectively, and/or a verification of the correct operation of the door (16).

4. Method according to claim 2, characterized in that, if the update process of the firmware of the safety control unit (26) leaves the safety control unit (26) longer than a predetermined duration or permanently inoperative, the door control unit (22) switches to a safe operating mode and/or if the update process of the firmware of the door control unit (22) leaves the door control unit (22) longer than a predetermined duration or permanently inoperative, the drive unit (20) switches to a safe operating mode.

5. Method according to claim 1, characterized in that, prior to initiating any update process, the safety control unit (26) verifies the received update package with respect to its authenticity, completeness, integrity and/or correctness, in particular cryptographically.

6. Method according to claim 2, characterized in that the safety control unit (26) determines a suitable point in time for initiating the update process of the firmware of the door control unit (22), of the drive unit (20) and/or of the safety control unit (26) and/or a suitable point in time for rebooting the door control unit (22), the drive unit (20) and/or the safety control unit (26).

7. Method according claim 1, characterized in that an abort condition is a software error during the update process, any condition that casts doubt on the correct operation of the door system and/or any condition that does not allow for the door system (10) to be inoperative for the time necessary to complete the update process, in particular a failed verification of the update package, an indication that the time necessary to complete the update process is shorter than the time the door (16) is not being used, a failed verification of the correct operation of the door (16) and/or the absence of a supervisor.

8. Method according to claim 3, characterized in that the safety sensor (24) comprises a camera (28), wherein the field of view (F) of the camera (28) includes the door component (18), the track of the door (16) and/or a safety zone in front of the door component (18), wherein the camera (28) captures at least one recording of the field of view (F), the safety control unit (26) evaluates the captured recording and sends instructions to the door control unit (22) to operate the door component (18) based on the captured recording.

9. Method according to claim 8, characterized in that the safety control unit (26) detects an abort condition based on the recording captured by the camera (28).

10. Method according to claim 8, characterized in that the safety sensor (24) and/or the safety control unit (26) determines a suitable point in time for initiating the update process of the firmware of the door control unit (22), of the drive unit (20) and/or of the safety control unit (26) and/or a suitable point in time for rebooting the door control unit (22), the drive unit (20) and/or the safety control unit (26) based on the recording captured by the camera (28) and/or past usage of the door (16), in particular the following steps are performed for the determination of a suitable point in time:
the safety sensor (24) and/or the safety control unit (26) estimates based on the recording the length of time that the door (16) will not be used,
the safety sensor (24) and/or the safety control unit (26) determines whether the length of time exceeds the time necessary to complete the update process and/or a reboot of the firmware of the door control unit (22), of the drive unit (20) and/or of the safety control unit (26), and
if so, the safety sensor (24) initiates the update process and/or the reboot of the firmware of the door control unit (22), of the drive unit (20) or of the safety control unit (26), respectively.

11. Method according to claim 10, characterized in that the mode of operation of the door (16), the past usage of the door (16) and/or the history of the modes of operation used are taken into account for the determination of a suitable point in time.

12. Method according to claim 10, characterized in that during the update process of the door control unit (22), the safety sensor (24) and/or the safety control unit (26) continues to estimate the length of time that the door (16) will not be used based on at least one further recording captured, if the length of time decreases below the time remaining to complete the update process of the door control unit (22), an abort condition is detected.

13. Method according to claim 8, characterized in that the verification of the correct operation of the door (16) is performed by the safety sensor (24) based on the recording captured by the camera (28), in particular the following steps are performed for the verification of the correct operation of the door (16):
the safety control unit (26) instructs the door control unit (22) to operate the door component (18) to perform a specific test movement,
the camera (28) captures a recording,
the safety control unit (26) recognizes the actual movement of the door component (18) in the recording and evaluates whether the actual movement corresponds to the test movement, in particular whether the actual movement is within a safe operation space, and
if the actual movement corresponds to the test movement, the verification is successful and, if the actual movement does not correspond to the test movement, the verification is not successful constituting an abort condition.

14. Method according to claim 13, characterized in that the following further steps are performed for the verification of the correct operation of the door (16):
the safety control unit (26) receives and/or determines an actual measurement value from a sensor of the door system (10) and/or from the drive unit (20),
the safety control unit (26) evaluates whether or not the actual measurement value corresponds to a target value or is within a target range defined by a safe operation space, and
if the actual measurement value corresponds to the target value or is within the target range, the verification in this regard is successful.

15. Method according to claim 8, characterized in that the safety control unit (26) recognizes the presence of a supervisor at the door (16) based on an input by the supervisor at a user terminal, wherein the absence of a supervisor constitutes an abort condition, and/or wherein the safety control unit (26) recognizes a person approaching the door based on the further recording captured, wherein a person approaching the door constitutes an abort condition.

16. Method according to claim 8, characterized in that the safety control unit (26) and/or a safety sensor (24) comprises an adaptive deterministic algorithm, a machine learning algorithm, a support vector machine and/or a trained artificial neural network, configured and/or trained to recognize an abort condition, a hazard, a person, a supervisor and/or the actual movement of the door component (18) in the captured recording, and/or configured and/or trained to estimate the length of time that the door (16) will not be used based on the captured recording.

17. Method according to claim 1, characterized in that the safety control unit (26) receives the update package via a wireless or wired connection, in particular from a remote sever (12) or from a mobile device (14) in the vicinity of the door system (10).

18. Method according to claim 1, characterized in that the initiation of an update process, the occurrence of an abort condition and/or a successful verification step is recorded in a log, in particular wherein the log is transmitted to a remote server (12) or a mobile device (14).

19. Method according to claim 1, characterized in that the safety control unit (26), the door control unit (22) and/or the drive unit (20) comprises a memory storing the deprecated firmware and the current firmware simultaneously, in particular both in a fully operational fashion, wherein the safety control unit (26), the door control unit (22) and/or the drive unit (20) is set back, if necessary, to the deprecated firmware by rebooting the respective unit (20, 22, 26) in the deprecated firmware.

20. Method according to claim 1, characterized in that the update package includes a firmware update for a subsystem (32) of the automatic door system (10), in particular for an operation terminal (34), a display terminal (36), a locking mechanism (38) and/or an escape route terminal (40) of the door system (10), wherein the safety control unit (26) initiates an update process of the firmware of the subsystem from the deprecated firmware to the current firmware, the safety control unit (26) controls the update process of the firmware of the subsystem, and if an abort condition is detected during the update process, the safety control unit (26) sets the subsystem back to the deprecated firmware.

21. Automatic door system comprising at least one door component (18), in particular a movable door leaf, at least one drive unit (20) for actuating the at least door component (18), a door control unit (22) for controlling the drive unit (20), and a safety sensor (24) having a safety control unit (26), wherein the door system (10) is configured to carry out the method according to any claim 1, in particular wherein the safety sensor (24) comprises a camera (28).
